(19) United States
(12) Patent Application Publication
(10) Pub. No.: US 2012/0183797 A1
(43) Pub. Date: Jul. 19, 2012

(54) POLYMER COMPOSITE COMPOSITION AND PLASTIC CONSTRUCTION MATERIAL

(75) Inventor: Ming-Yu CHEN, Tainan City (TW)

(73) Assignee: WIN TON PLASTICS INDUSTRY CO., LTD., Tainan City (TW)

(21) Appl. No.: 13/351,860

(22) Filed: Jan. 17, 2012

(30) Foreign Application Priority Data
Jan. 19, 2011 (TW) 100101927

(51) Int. Cl. B32B 27/08; C08L 23/20

(52) U.S. Cl. 428/515; 524/528

(57) ABSTRACT

A polymer composite composition includes a polyolefin, a thermoplastic polyolefin elastomer, and a filler. The filler is in an amount ranging from 40 to 90 wt % based on the weight of the polymer composite composition. The weight ratio of the thermoplastic polyolefin elastomer to the polyolefin ranges from 19:1 to 1:19.

### CROSS-REFERENCE TO RELATED APPLICATION

This application claims priority of Taiwanese Patent application no. 100101927, filed on Jan. 19, 2011.

### BACKGROUND OF THE INVENTION

1. Field of the Invention

The invention relates to a polymer composite composition and a plastic construction material, particularly to a polymer composite composition including a polyolefin, a thermoplastic polyolefin elastomer and a filler.

2. Description of the Related Art

Plastic construction materials, such as wall tiles or floor tiles, are normally made from a laminate of a base layer, an intermediate layer formed on the base layer and having a printed pattern, and a top layer formed on the intermediate layer. The base layer, the intermediate layer and the top layer are made from materials containing polyvinyl chloride (PVC) and plasticizers, such as di-(2-ethylene hexyl)phthalate (DEHP). DEHP is toxic and harmful to the environment and humans. In addition, PVC is unstable and tends to deteriorate due to exposure to sunlight and heat. Hence, PVC materials normally contain stabilizers, such as salts of lead, cadmium, zinc, barium, and tin. However, these metal salts tend to be released from the PVC materials, which can be harmful to the environment and humans.

Hence, there is a need to provide a plastic construction material that is free of PVC, the plasticizer and the stabilizer.

### SUMMARY OF THE INVENTION

Therefore, an object of the present invention is to provide a polymer composite composition and a plastic construction material that can overcome the aforesaid drawbacks associated with the prior art.

According to one aspect of the present invention, there is provided a polymer composite composition that comprises a polyolefin, a thermoplastic polyolefin elastomer, and a filler. The filler is in an amount ranging from 40 to 90 wt % based on the weight of the polymer composite composition. The weight ratio of the thermoplastic polyolefin elastomer to the polyolefin ranges from 19:1 to 1:19.

According to another aspect of the present invention, there is provided a plastic construction material that comprises a base layer of a polymer composite having a composition comprising: a polyolefin; a thermoplastic polyolefin elastomer; and a filler. The filler is in an amount ranging from 40 to 90 wt % based on the weight of the composition. The weight ratio of the thermoplastic polyolefin elastomer to the polyolefin ranges from 19:1 to 1:19.

### BRIEF DESCRIPTION OF THE DRAWINGS

In drawings which illustrate embodiments of the invention,

FIG. 1 is a sectional view of the first preferred embodiment of a plastic construction material according to the present invention;

FIG. 2 is a sectional view of the second preferred embodiment of a plastic construction material according to the present invention;

FIG. 3 is a schematic view to illustrate how a printed top layer is assembled to an intermediate layer and a base layer to form the second preferred embodiment; and

FIG. 4 is a schematic view to illustrate how a printed intermediate layer is assembled to a top layer and a base layer to form the second preferred embodiment.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

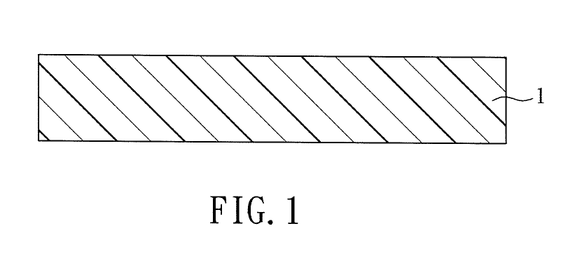

FIG. 1 illustrates the first preferred embodiment of a plastic construction material according to the present invention. The plastic construction material of the first preferred embodiment includes solely a base layer 1 of a first polymer composite. The first polymer composite has a first composition comprising a crystalline first polyolefin, a first thermoplastic polyolefin elastomer, and a first filler.

The first thermoplastic polyolefin elastomer is a copolymer of first and second monomers, and exhibits rubber-like elasticity so as to impart a desired flexibility and softness to the base layer 1. The first monomer is preferably selected from ethylene and propylene. The second monomer is preferably selected from butene, pentene, and a combination thereof. The first thermoplastic polyolefin elastomer can be molded under an elevated temperature.

The crystalline first polyolefin is non-toxic, lightweight and resistant to corrosion, and is preferably selected from the group consisting of polyethylene, polypropylene, and a combination thereof.

The first filler serves to impart a desired hardness, and a good insulation and resistance to heat to the base layer 1. The first filler can be in the form of fiber or powder, e.g., organic powder, inorganic powder. The first filler is preferably selected from calcium carbonate powder, wollastonite powder, barium sulfate powder, talcum powder, clay powder, calcined ceramic powder, natural fibers, glass fiber, and combinations thereof.

Optionally, the first composition of the first polymer composite can further include dyeing agents, plasticizers, softening agents, lubricants, modifiers, flame retardants, and combinations thereof. In addition, the first composition of the first polymer composite can further include copolymers, such as ethylene vinyl acetate copolymer, ethylene copolymer and propylene copolymer, so as to achieve a desired property.

The hardness and the impact strength of the plastic construction material can be adjusted by varying the first composition of the first polymer composite according to actual requirements for different applications. In order to meet specifications of various applications, such as wall tiles, floor tires, and decorative articles, the filler is preferably in an amount ranging from 40 to 90 wt % based on the weight of the composition, and the weight ratio of the thermoplastic polyolefin elastomer to the polyolefin preferably ranges from 19:1 to 1:19.

Note that the impact strength of the plastic construction material may become insufficient for the aforementioned applications when the first thermoplastic polyolefin elastomer is not present or is present in a relatively low amount in the base layer 1.

Since the crystalline first polyolefin has a high melting point, melt blending of the crystalline first polyolefin and the first thermoplastic polyolefin elastomer will be difficult to proceed when the weight percentage of the crystalline first polyolefin is too high. In addition, since the crystalline first polyolefin is fragile, the impact strength of the plastic construction material can become relatively poor when the weight ratio of the first thermoplastic polyolefin elastomer to the first polyolefin is too low. Hence, the weight ratio of the first thermoplastic polyolefin elastomer to the first polyolefin preferably ranges from 19:1 to 1:1, and more preferably from 19:1 to 2:1 so that the melt blending can proceed smoothly and that the plastic construction material thus formed can have a high impact strength with a suitable hardness.

The merits of the plastic construction material of this invention will become apparent from the following Examples. The plastic construction materials of Examples 1-19 differ from each other in the weight ratio of the components of the polymer composite composition. In addition, all of Examples 1-19 use calcium carbonate as the first filler. Table 1 lists the compositions and the measured hardness of the plastic construction materials of Examples 1-19 and the measured impact strength of the plastic construction materials of Examples 2-18. The impact strength was measured using a Charpy impact tester (catalog number: Gotech CT-7045-MD).

TABLE 1

| | | | | | | Impact | |
|---|---|---|---|---|---|---|---|
| | | Poly- | | Ratio of | Shore | strength | |
| | TPOE | olefin | Filler | TPOE to | Hardness | Kg-cm/ | Specific |
| Exp. | wt % | wt % | wt % | polyolefin | (D) | cm² | density |
| E1 | 45 | 3 | 40 | 15/1 | 48 | — | 1.167 |
| E2 | 50 | 10 | 40 | 5/1 | 48 | 4.12 | 1.194 |
| E3 | 40 | 20 | 40 | 2/1 | 49 | 4.08 | 1.227 |
| E4 | 40 | 10 | 50 | 4/1 | 51 | 3.92 | 1.283 |
| E5 | 30 | 20 | 50 | −3/2 | 54 | 3.82 | 1.352 |
| E6 | 34 | 6 | 60 | 5.7/1 | 52 | 3.87 | 1.396 |
| E7 | 33 | 7 | 60 | 4.7/1 | 53 | 3.84 | 1.414 |
| E8 | 32 | 8 | 60 | 4/1 | 54 | 3.78 | 1.416 |
| E9 | 30 | 10 | 60 | 3/1 | 55 | 3.76 | 1.439 |
| E10 | 27 | 13 | 60 | 2/1 | 56 | 3.71 | 1.528 |
| E11 | 25 | 5 | 70 | 5/1 | 56 | 3.67 | 1.657 |
| E12 | 20 | 10 | 70 | 2/1 | 57 | 3.63 | 1.779 |
| E13 | 19 | 1 | 80 | 19/1 | 59 | 3.51 | 1.80 |
| E14 | 16 | 4 | 80 | 4/1 | 60 | 3.47 | 1.83 |
| E15 | 15 | 5 | 80 | 3/1 | 62 | 3.47 | 1.849 |
| E16 | 13.4 | 6.6 | 80 | 2/1 | 64 | 3.41 | 1.86 |
| E17 | 10 | 10 | 80 | 1/1 | 66 | 3.36 | 1.865 |
| E18 | 1 | 19 | 80 | 1/19 | 71 | 3.15 | 1.788 |
| E19 | 8 | 3 | 89 | 8/3 | 62 | — | 2.055 |

Table 1 shows that the plastic construction materials of Examples 1-17 and Example 19 have a Shore hardness ranging from 48 to 66 (Shore D) which is similar to that of commercially known PVC construction materials which ranges from 50 to 65 (Shore D). In addition, the plastic construction materials of Examples 2-17 have an impact strength ranging from 3.36 to 4.12 kg-cm/cm² which is better than that of the PVC construction materials which ranges from 2.84 to 3.39 kg-cm/cm². Hence, the plastic construction materials of this invention can replace the conventional PVC construction materials in applications, such as floor panels and wall panels, thereby eliminating the aforesaid drawbacks encountered with use of PVC construction materials.

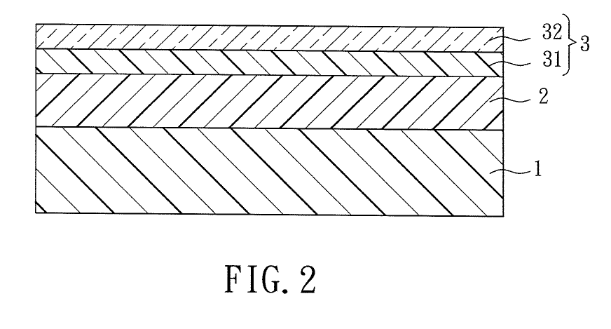

FIG. 2 illustrates the second preferred embodiment of a plastic construction material according to the present invention. The second preferred embodiment differs from the previous embodiment in that the second preferred embodiment further includes a top layer 3 and an intermediate layer 2 disposed between the top layer 3 and the base layer 1. The top layer 3, the intermediate layer 2 and the base layer 1 are thermally laminated.

The intermediate layer 2 is made from a second polymer composite having a second composition that comprises: a second polyolefin; a second thermoplastic polyolefin elastomer; and a second filler.

The second polyolefin is selected from the species listed in the aforesaid group from which the first polyolefin is selected. The second thermoplastic polyolefin elastomer is a copolymer of the aforesaid first and second monomers. The second filler is selected from the species listed in the aforesaid group from which the first filler is selected.

The second filler is in an amount ranging from 10 to 30 wt % based on the weight of the second composition. The weight ratio of the second thermoplastic polyolefin elastomer to the second polyolefin ranges from 4:1 to 1:4. Optionally, the second composition can further include flame retardants or other additives.

The top layer 3 includes a printed sub-layer 31 bonded to the intermediate layer 2, and a surface sub-layer 32 formed on the printed sub-layer 31 and made from a polymer blend having a third composition that comprises a third polyolefin and a third thermoplastic polyolefin elastomer. The third thermoplastic polyolefin elastomer is in an amount ranging from 50 to 90 wt % based on the weight of the third composition.

The third polyolefin is also selected from the species listed in the aforesaid group from which the first polyolefin is selected. The third thermoplastic polyolefin elastomer is also a copolymer of the aforesaid first and second monomers.

The third thermoplastic polyolefin elastomer is compatible with that of the third polyolefin so that the former can be uniformly blended with the latter under high temperature or high pressure conditions. Optionally, the third composition can further include flame retardants, abrasive materials, or other additives. The surface sub-layer 32 can protect the printed sub-layer 31 from damage and is transparent so as to permit viewing therethrough.

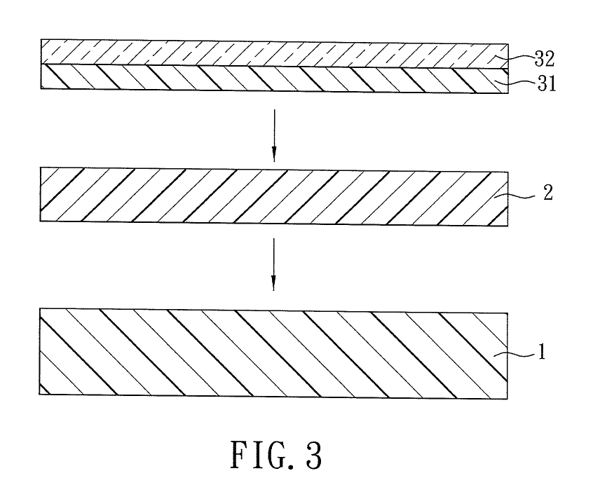

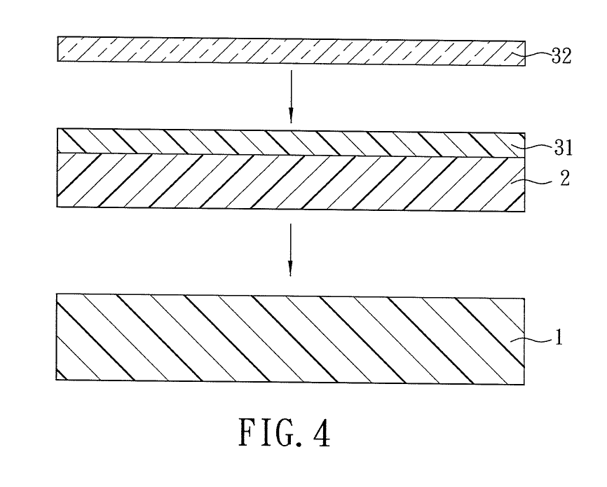

Formation of the second preferred embodiment can be conducted by a first method that includes printing the printed sub-layer 31 on the surface sub-layer 32 to form the top layer 3 (see FIG. 3), assembling the top layer 3, the intermediate layer 2 and the base layer 1, and thermally laminating the assembly of the top layer 3, the intermediate layer 2 and the base layer 1. Alternatively, formation of the second preferred embodiment can be conducted by a second method that includes printing the printed sub-layer 31 on the intermediate layer 2 (see FIG. 4), assembling the surface sub-layer 32, the intermediate layer 2 with the printed sub-layer 31 thereon, and the base layer 1, and thermally laminating the assembly of the surface sub-layer 32, the printed sub-layer 31, the intermediate layer 2, and the base layer 1.

The use of polyolefin, thermoplastic polyolefin elastomer and/or filler as materials for making the base layer 1, the top layer 3 and the intermediate layer 2 of the plastic construction material can eliminate the aforesaid drawbacks as encountered with use of PVC material and plasticizer.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A polymer composite composition comprising:
a polyolefin;
a thermoplastic polyolefin elastomer; and
a filler;
wherein said filler is in an amount ranging from 40 to 90 wt % based on the weight of said polymer composite composition; and
wherein the weight ratio of said thermoplastic polyolefin elastomer to said polyolefin ranges from 19:1 to 1:19.

2. The polymer composite composition of claim 1, wherein said filler is in an amount ranging from 60 to 80 wt % based on the weight of said polymer composite composition.

3. The polymer composite composition of claim 1, wherein said polyolefin is crystalline.

4. The polymer composite composition of claim 3, wherein said polyolefin is selected from the group consisting of polyethylene, polypropylene, and a combination thereof.

5. The polymer composite composition of claim 1, wherein said thermoplastic polyolefin elastomer is a copolymer of first and second monomers, said first monomer being selected from ethylene and propylene, said second monomer being selected from butene, pentene, and a combination thereof.

6. The polymer composite composition of claim 1, wherein the weight ratio of said thermoplastic polyolefin elastomer to said polyolefin ranges from 19:1 to 1:1.

7. The polymer composite composition of claim 6, wherein the weight ratio of said thermoplastic polyolefin elastomer to said polyolefin ranges from 19:1 to 2:1.

8. A plastic construction material comprising:
a base layer of a first polymer composite having a first composition comprising:
a first polyolefin;
a first thermoplastic polyolefin elastomer; and
a first filler;
wherein said first filler is in an amount ranging from 40 to 90 wt % based on the weight of said first composition; and
wherein the weight ratio of said first thermoplastic polyolefin elastomer to said first polyolefin ranges from 19:1 to 1:19.

9. The plastic construction material of claim 8, further comprising a top layer and an intermediate layer disposed between said top layer and said base layer, said intermediate layer being made from a second polymer composite having a second composition comprising:
a second polyolefin;
a second thermoplastic polyolefin elastomer; and
a second filler;
wherein said second filler is in an amount ranging from 10 to 30 wt % based on the weight of said second composition; and
wherein the weight ratio of said second thermoplastic polyolefin elastomer to said second polyolefin ranges from 4:1 to 1:4.

10. The plastic construction material of claim 9, wherein said top layer includes a printed sub-layer bonded to said intermediate layer, and a surface sub-layer formed on said printed sub-layer and made from a polymer blend having a third composition comprising a third polyolefin and a third thermoplastic polyolefin elastomer, said third thermoplastic polyolefin elastomer being in an amount ranging from 50 to 90 wt % based on the weight of said third composition.
